(19) United States
(12) Patent Application Publication
(10) Pub. No.: US 2018/0118866 A1
(43) Pub. Date: May 3, 2018

(54) USE OF ACRYLATE RUBBERS HAVING IMPROVED LOW-TEMPERATURE PROPERTIES AND GOOD OIL RESISTANCE FOR PRODUCING VULCANIZABLE MIXTURES AND VULCANIZED PRODUCTS

(71) Applicant: ARLANXEO DEUTSCHLAND GMBH, DORMAGEN (DE)

(72) Inventors: RAINER KALKOFEN, LEVERKUSEN (DE); ULRICH FRENZEL, DORMAGEN (DE); HIYAM SALEM, COLOGNE (DE); FRANK TASCHNER, MONHEIM (DE); SUSANNA LIEBER, KAISERSLAUTERN (DE)

(73) Assignee: ARLANXEO DEUTSCHLAND GMBH, DORMAGEN (DE)

(21) Appl. No.: 15/568,944

(22) PCT Filed: Apr. 29, 2016
(86) PCT No.: PCT/EP2016/059613

§ 371 Date: Oct. 24, 2017

(30) Foreign Application Priority Data
Apr. 30, 2015 (EP) 15165824.2

(51) Int. Cl. C08F 220/14; C08K 3/04; C08F 220/18; C08J 3/24

(52) U.S. Cl. CPC C08F 220/14; C08K 3/04; C08F 2220/1808; C08J 3/24; C08F 220/18

(57) ABSTRACT

The present invention relates to the use of copolymers of alkyl acrylates, specific unsaturated carboxylic esters and optionally ethylene that combine a low glass transition temperature with oil resistance in the manufacture of vulcanizable mixtures, the crosslinking thereof and thereby obtainable vulcanizates and shaped articles.

Polymers of acrylate monomers and copolymers of acrylate monomers and ethylene, in particular acrylate rubbers (ACM) and ethylene-acrylate copolymers (AEM), are rubbers which are produced on a large industrial scale and from which, for example via free-radical crosslinking or crosslinking by means of cure-site monomers incorporated in the main chain, it is possible to produce vulcanizates notable in particular for oil and media resistance and also ageing resistance.

However, the increasingly important requirement of low-temperature flexibility combined with a low Oil Swell is but barely satisfied by the ACM and AEM rubbers currently available on the market, since hitherto oil resistance could only be improved by sacrificing low-temperature flexibility at the same time. AEM and ACM rubbers typically exhibit a relationship between glass transition temperature and Oil Swell in that as the polarity of the acrylate used increases, the Oil Swell decreases but at the same time the glass transition temperature rises, and vice versa. Past attempts to reduce the glass transition temperature while keeping the Oil Swell the same, or to reduce the Oil Swell while keeping the glass transition temperature the same, by incorporation of various additional comonomers were not entirely successful.

Different approaches to improving the low-temperature properties of ACM and AEM rubbers are described in the literature:

Employing plasticizers to improve the low-temperature properties of ACM and AEM vulcanizates is one possibility. However, particularly the most effective plasticizers for improving the low-temperature properties, e.g. Rhenosin 759, dioctyl adipate (DOA), dioctyl sebacate (DOS) or citric esters such as, for example, tri(2-ethylhexyl) acetylcitrate or tributyl acetylcitrate, are relatively volatile and therefore frequently lead to problems with the heat-ageing of the vulcanizates, this being particularly problematical in the case of ACM and AEM because these rubbers are preferentially employed in high-temperature applications. In addition, the plasticizer quantity which can be admixed is limited, since it is otherwise no longer possible to attain the required hardness and/or other vulcanizate properties such as, for example, elongation at break and/or tensile strength. Problems can further arise due to exudation of the plasticizer, migration of the plasticizer out of the vulcanizate, or plasticizer extraction. Therefore, rather than merely employing a plasticizer, it is preferable to lower the glass transition temperature of the rubber used: the formulator is freer to select the plasticizer and its dosage, or may, if desired, even completely eschew any admixture thereof without having to accept sacrifices in the low-temperature properties of the vulcanizate or in the heat-ageing. On the other hand, by combining the improved rubber of lower glass transition temperature with suitable plasticizers, the service temperature range of the rubber and/or of the vulcanizate produced therefrom may additionally be extended in the downwards direction.

AEM rubbers are familiar rubbers which are produced on a large industrial scale and which have oil resistance, thermal stability and excellent UV stability. They are commercially available copolymers formed from the monomers ethylene, methyl acrylate, butyl acrylate or similar alkyl acrylates and optionally a further cure-site monomer such as monoalkyl fumarate or monoalkyl maleate. Ethylene-acrylate rubbers are typically produced in a high-pressure process at a pressure of 900 to 2800 bar and polymerized at temperatures above 100° C., U.S. Pat. No. 2,599,123 describes the preparation of ethylene/methyl acrylate/monoalkyl maleate copolymers in a batch method under these conditions. The admixture of a solvent such as methanol during the polymerization, as described in U.S. Pat. No. 4,026,851, reduces the on-stream times of the reactors used. Commercially available ethylene-acrylate rubbers are typically crosslinked peroxidically or with polyamine and/or a carbamated diamine such as DIAK No.1. This is related in U.S. Pat. No. 3,883,472 or U.S. Pat. No. 4,026,851 for example.

EP 1654687 relates that while the use of an alkyl acrylate, in particular butyl acrylate, as further monomer improves low-temperature flexibility, Oil Swell is simultaneously raised by the use of the less polar monomer. Adequate improvement in low-temperature flexibility coupled with retention of good Oil Swell has therefore hitherto not been disclosed for AEM in the prior art.

ACM rubbers are produced in the emulsion process and consist of mixtures of various acrylates. Ethyl acrylate and butyl acrylate are the most common monomers, usually used together with suitable cure-site monomers, such as chlorovinyl acetate, chloroethyl vinyl ether, 4-vinylbenzyl chloride, glycidyl methacrylate, acrylic acid, monoalkyl maleate or monoalkyl fumarate. To improve the low-temperature properties, 2-methoxyethyl acrylate may be interpolymerized as described in EP 905182. In general, a longer alkyl group can be used to improve cold resistance, yet oil resistance suffers. A shorter alkyl group then shows the opposite effect. Alkoxy acrylates improve both cold resistance and oil resistance, and there continues to be the need for further improvement in cold resistance.

J.-F. Lutz et al. describe, for example in J. Polym. Sci., Polym. Chem. 2008, 46, 3459 and Macromolecules 2006, 39, 893, the polymerization of polyethylene glycol methacrylates to synthesize polymers having enhanced solubility in water, in some instances as a function of temperature. Copolymers of polyethylene glycol methacrylates with ethylene and/or other acrylates are not described.

DE 19942301 describes preparing a polymer from alkyl acrylates, vinylaromatics and alkyl polyethoxyacrylates. The polymers obtained are employed as redispersible modifiers for cement. Usage of the polymers obtained to produce vulcanizates and vulcanizable mixtures is not disclosed, nor the vulcanizates themselves and improved properties thereof.

The problem addressed by the present invention was that of providing acrylate polymers and copolymers from ethylene and acrylates and also their use in the manufacture of vulcanizates and vulcanizable mixtures having improved low-temperature properties combined with oil resistance while avoiding the disadvantages of the prior art and preferably inferior ageing properties.

This problem is solved by copolymers containing
i) 49 to 99 wt %, preferably 55 to 90 wt % of repeat units derived from at least one alkyl acrylate other than repeat units ii),
ii) 1 to 51 wt % of repeat units derived from at least one monomer of general formula (I)

CH₂═C(R¹)(COO(R²O)ₙR³) (I)

where
R¹ represents hydrogen or methyl,
R² at each occurrence independently represents a linear or branched C₂ to C₆ alkylene group,
R³ represents hydrogen, unsubstituted or C₁-C₃ alkyl substituted phenyl, a linear or branched C₁-C₈ alkyl group or —C(═O)R⁴,
R⁴ represents hydrogen or a linear or branched C₁-C₈ alkyl group, and
n represents a number from 2 to 30, and
iii) 0 to 50 wt %, preferably 0 to 45 wt % of repeat units derived from ethylene, wherein the amounts are each based on the combined amount of repeat units i) to iii).

“Copolymers” for the purposes of this invention is thus to be understood as meaning polymers that contain copolymerized units of two or more different monomers, while polymers according to the present invention contain copolymerized units of three or more different monomers.

Useful alkyl acrylates for introducing repeat units i) differ from repeat units ii) and are preferably selected from acrylates having an alkyl group of 1 to 10 carbon atoms, such as methyl acrylate, ethyl acrylate, propyl acrylate, isopropyl acrylate, n-butyl acrylate, n-hexyl acrylate, 3-propylheptyl acrylate, 2-ethylhexyl acrylate, n-octyl acrylate and also mixtures thereof, more preferably methyl acrylate, ethyl acrylate and n-butyl acrylate and also mixtures thereof.

The monomers of general formula (I) have R² moieties which at each occurrence are independently selected from the group containing ethane-1,2-diyl, propane-1,3-diyl, propane-1,2-diyl, butane-1,4-diyl, butane-1,3-diyl, pentane-1,3-diyl, pentane-1,4-diyl, pentane-1,5-diyl and 2-methylbutane-1,4-diyl, preferably from ethane-1,2-diyl, propane-1,3-diyl, propane-1,2-diyl and butane-1,4-diyl, more preferably from ethane-1,2-diyl and propane-1,2-diyl. The expression “at each occurrence independently” here is intended to make clear that various R² moieties may be present in one molecule. The different R²O units resulting therefrom may have any desired random, alternating or blockwise arrangement in the polyether chain of the molecule.

The R³ moieties of monomers of general formula (I) are selected from the group containing H, CH₃, CH₂CH₃, CH₂CH₂CH₃, CH₂CH₂CH₂CH₃, CHO, COCH₃, COCH₂CH₃, COCH₂CH₂CH₃ and COCH₂CH₂CH₂CH₃, preferably from the group containing H, CH₃, CH₂CH₃ and COCH₃ and more preferably from the group containing CH₃, CH₂CH₃ and COCH₃. Useful monomers of general formula (I) include mixtures of two or more different monomers of general formula (I) which differ as for example in the moieties R¹, R² and/or R³ or in the number “n” of repeat units.

Examples of monomers of general formula (I) are polyethylene glycol acrylate, polyethylene glycol methacrylate, polypropylene glycol acrylate, polypropylene glycol methacrylate, mixed poly(ethylene glycol propylene glycol) acrylate or poly(ethylene glycol propylene glycol) methacrylate or poly(THF) acrylate or poly(THF) methacrylate. Particular preference is given to methoxy- or ethoxy-terminated polyethylene glycol acrylate and/or methacrylate, methoxy- or ethoxy-terminated polypropylene glycol acrylate and/or methacrylate having 2 to 25 ethylene glycol or propylene glycol repeat units, most preferably having 2 to 20 ethylene glycol or propylene glycol repeat units.

The level of repeat units of general formula (I) is preferably from 2 to 40 wt %, more preferably from 4 to 25 wt % and most preferably from 6 to 20 wt %, all based on the sum total of repeat units i) to iii).

In a preferred embodiment, the proportion of repeat units derived from ethylene is more than 5 wt %, preferably more than 10 wt % and more preferably more than 20 wt %, all based on the combined amount of repeat units i) to iii).

The copolymers of the present invention may further include one or more further copolymerized monomers (iv), i.e. copolymers that do not fall within the above definition for monomers of repeat units i) to iii), in a combined amount of less than 25 wt %, preferably less than 20 wt %, more preferably less than 15 wt %, yet more preferably less than 10 wt %, yet still more preferably less than 5 wt % and most preferably less than 1 wt %, all based on the combined amount of repeat units i) to iii) and of the one or more further copolymerized monomers (iv).

These further monomers (iv) are typically selected from the group containing epoxy-containing acrylates, epoxy-containing methacrylates, alkoxyalkyl acrylates having an alkoxyalkyl group of 2 to 8 carbon atoms, vinyl ketones, vinylaromatic compounds, conjugated dienes, α-monoolefins, vinyl monomers having a hydroxyl group, chlorovinyl acetate, monoalkyl maleate, monoalkyl fumarate, acrylic acid, methacrylic acid, vinylidene fluoride, hexafluoropropene, vinylidene chloride, tetrafluoroethylene, tetrachloroethylene, vinyl chloride, unsaturated amide monomers, carbon monoxide and mixtures thereof, preferably from methyl acrylate, ethyl acrylate, propyl acrylate, n-butyl acrylate, 2-ethylhexyl acrylate, n-octyl acrylate, glycidyl methacrylate, divinyl adipate, methyl vinyl ketone, ethyl vinyl ketone, styrene, α-methylstyrene, vinyltoluene, butadiene, isoprene, propylene, 1-butene, β-hydroxyethyl acrylate, 4-hydroxybutyl acrylate, 3-cyanoethyl acrylate, acrylamide, N-methylmethacrylamide, 2-methoxyethyl acrylate, chlorovinyl acetate, monoalkyl maleate, monoalkyl fumarate, carbon monoxide and mixtures thereof and more preferably from acrylic acid, methacrylic acid, 2-methoxyethyl acrylate, glycidyl methacrylate, chlorovinyl acetate, monoalkyl maleate, monoalkyl fumarate, carbon monoxide and mixtures thereof.

In a particularly preferred embodiment, the copolymers of the present invention comprise copolymers containing repeat units derived from ethylene, methyl acrylate and polyalkylene glycol (meth)acrylates having 2 to 20 ethylene glycol and/or propylene glycol repeat units. In further preferred embodiments, there are additionally present repeat units derived from butyl acrylate, monoalkyl maleate and/or monoalkyl fumarate.

In a further particularly preferred embodiment, the copolymers of the present invention comprise copolymers containing repeat units derived from two or more alkyl acrylates, preferably ethyl acrylate and butyl acrylate, and polyalkylene glycol (meth)acrylates having 2 to 20 ethylene glycol and/or propylene glycol repeat units. In further preferred embodiments, there are additionally present repeat units derived from (meth)acrylic acid, glycidyl methacrylate, chlorovinyl acetate, monoalkyl maleate, monoalkyl fumarate.

A very particularly preferred embodiment contains, in each case based on repeat units i) and ii): at least 10 wt % of ethyl acrylate, at least 10 wt % of butyl acrylate, up to 20 wt % of monomers of formula (I) and up to 10 wt %, preferably up to 5 wt %, of further monomers selected from the group containing epoxy-containing acrylates, epoxy-containing methacrylates, chlorovinyl acetate, monoalkyl maleate, monoalkyl fumarate, acrylic acid, methacrylic acid, vinylidene chloride, vinyl chloride and mixtures thereof.

In the copolymers of the present invention, the monomers form a random distribution, an alternating distribution or a blockwise distribution, preferably a random distribution.

The glass transition temperatures of the copolymers according to the present invention are typically in the range from +10° C. to −50° C., preferably in the range from 0° C. to −45° C. and more preferably in the range from −5° C. to −40° C. (as measured by DSC at a heating rate of 20 K/min).

The invention further provides a process for producing the copolymers of the present invention, wherein acrylates, monomers of general formula (I) and optionally one or more further monomers (iv) are polymerized by free-radical polymerization.

In a preferred embodiment, the process for producing the copolymers of the present invention is carried out by starting the polymerization reaction and then adding monomers of general formula (I) to the reaction mixture. Some of the total amount used of monomers of general formula (I) may already be present in the reaction mixture at the start of the polymerization reaction, or all the monomers of general formula (I) may be added only after the start of the polymerization reaction.

The present invention also provides vulcanizable mixtures containing copolymers of the present invention and optionally one or more crosslinkers. The latter are not required for compositions that are vulcanized by radiative crosslinking. Mixtures and compositions may be regarded as interchangeable terms in this invention.

Useful crosslinkers include, for example, peroxidic crosslinkers such as bis(2,4-dichlorobenzyl) peroxide, dibenzoyl peroxide, bis(4-chlorobenzoyl) peroxide, 1,1-bis(t-butylperoxy)-3,3,5-trimethylcyclohexane, tert-butyl perbenzoate, 2,2-bis(t-butylperoxy)butene, 4,4-di-tert-butylperoxynonyl valerate, dicumyl peroxide, 2,5-dimethyl-2,5-di(t-butylperoxy)hexane, tert-butyl cumyl peroxide, 1,3-bis(t-butylperoxyisopropyl)benzene, di-t-butyl peroxide and 2,5-dimethyl-2,5-di(t-butylperoxy)hex-3-yne. The combined amount of crosslinker(s) is typically in the range from 0.5 to 15 phr, preferably in the range from 1 to 10 phr and more preferably in the range from 1.5 to 6 phr, based on the copolymers of the present invention. Supported peroxides may be used here with preference, in which case the recited amounts have to be corrected for the amount of the support.

It may be advantageous to use these peroxidic crosslinkers together with further ingredients known as coagents to enhance the crosslinking yield. Useful coagents include, for example, triallyl isocyanurate, triallyl cyanurate, trimethylolpropane trimethacrylate, triallyl trimellitate, ethylene glycol dimethacrylate, butanediol dimethacrylate, trimethylolpropane triacrylate, zinc diacrylate, zinc dimethacrylate, 1,2-polybutadiene or N,N′-m-phenylenedimaleimide. The combined amount of coagent(s) is typically in the range from 0.2 to 10 phr, preferably from 0.4 to 4 phr, more preferably from 0.6 to 2 phr, based on the copolymers of the present invention. Again, supported compounds may be employed here, in which case the recited amounts have to be corrected for the mass of the support.

Crosslinking by admixing a polyacid or a polyacid anhydride and suitable accelerators is a possible alternative to peroxidic crosslinking when copolymers according to the present invention contain epoxy functionalities which may be introduced for example through use of glycidyl methacrylate as an additional monomer. Glutaric acid or adipic acid, for example, may be used as polyacid and tetrabutylammonium bromide as accelerator.

When copolymers contain monoalkyl fumarate or maleate, the usual choice will be to use an aliphatic or aromatic diamine compound as vulcanizing agent and a base as vulcanization accelerator. Aliphatic or aromatic diamine compounds include, for example, hexamethylenediamine, hexamethylenediamine carbamate, 4,4′-methylenedianiline, m-phenylenediamine, 4,4′-diaminodiphenyl ether, p-phenylenediamine, p,p′-ethylenedianiline, 4,4′-(p-phenylenediisopropylidene)dianiline, 4,4′-(m-phenylenediisopropylidene)dianiline, 3,4′-diaminodiphenyl ether, 4,4′-diaminodiphenyl sulphone, 2,2-bis[4-(4-aminophenoxy)phenyl)propane, bis[4-(4-aminophenoxy)phenyl] sulphone, bis[4-(3-aminophenoxy)phenyl] sulphone, 4,4′-bis(4-aminophenoxy)biphenol, bis[4-(4-aminophenoxy)phenyl] ether, 2,2-bis[4-(4-aminophenoxy)phenyl]hexafluoropropane, 1,4-bis(4-aminophenoxy)benzene and 1,3-bis(4-aminophenoxy)benzene, whereamong p-amino-disubstituted compounds and hexamethylenediamine carbamate are preferable. The diamine compound is used in an amount of about 0.1 to about 5 phr, preferably about 0.2 to about 4 phr, more preferably about 0.5 to about 3 phr. Below about 0.1 phr, vulcanization will not be satisfactory and no satisfactory compression set characteristics can be obtained, whereas above about 5 parts by weight scorching will occur with the failure of vulcanization. Useful bases include, for example, guanidine and bi- or polycyclic aminic bases such as 1,8-diazabicyclo[5,4,0]undec-7-ene (DBU), 1,5-diazabicyclo[4,3,0]-5-nonene (DBN), 1,4-diazabicyclo[2,2,2]octane (DABCO), 1,5,7-triazabicyclo[4,4,0]dec-5-ene (TBD), 7-methyl-1,5,7-triazabicyclo[4,4,0]dec-5-ene (MTBD) and derivatives thereof. Mixtures of these compounds are likewise employable. The chemicals may be employed in pure form or in a predispersed form. Predispersed chemicals may utilize inter alia polyethylene waxes or ethylene-vinyl acetate copolymers as carrier materials. The bases may further also be used in protonated form, for example with a formate or acetate as counterion.

The list of usable guanidines includes guanidine itself, diphenylguanidine (DPG), tetramethylguanidine, tetraethylguanidine, N,N′-di-o-tolylguanidine (DOTG), etc., whereamong diphenylguanidine and N,N′-di-o-tolylguanidine are preferable. The base is used in an amount of about 0.1 to about 10 phr, preferably about 0.3 to about 6 phr, more preferably about 0.5 to about 4 phr.

Copolymers having halogen-containing or halogen- and carboxyl-containing repeat units may be vulcanized by using inter alia sulphur, triazines such as 2,4,6-trimercapto-S-triazine or trithiocyanuric acids such as 1,3,5-triazine-2,4,6-trithiol as vulcanizing agents. Useful accelerators include guanidines such as, for example, 1,3-di-o-tolylguanidine or diphenylguanidine, thiurams and/or thiuram polysulphides such as, for example, dipentamethylenethiuram tetrasulphide or tetrabutylthiuram disulphide, urea derivatives such as, for example, N,N′-diethylthiourea or N,N′-dimethylthiourea, diuron, tetraalkylammonium halides such as octadecyltrimethylammonium bromide, cetyltrimethylammonium bromide or tetrabutylammonium bromide, carboxylates such as, for example, sodium stearate, potassium stearate or ammonium benzoate, stearic acid, dithiocarbamates and/or salts thereof such as, for example, zinc dimethyldithiocarbamate, zinc diethyldithiocarbamate, zinc dibutyldithiocarbamate or iron dimethyldithiocarbamate in an amount of 1 to 15 phr, preferably 1.5 to 10 phr. The vulcanizing agents may be used singly or in combination.

As an alternative to these forms of crosslinking, high-energy rays, for example beta or gamma rays, may also be used to crosslink the copolymers of the present invention, and in this case too the abovementioned coagents may be employed to improve the crosslinking yield.

Optionally, vulcanizable mixtures of this type may further also contain one or more of the additives and fibrous materials familiar to a person skilled in the rubber arts. These include, for example, fillers, plasticizers, ageing control agents, light stabilizers, processing aids, tackifiers, blowing agents, dyes, pigments, waxes, resins, organic acids and/or salts thereof, vulcanization retarders, metal oxides, fibres and also filler activators or other additives known in the rubber industry (see, for example, Ullmann's Encyclopedia of Industrial Chemistry, VCH Verlagsgesellschaft mbH, D-69451 Weinheim, 1993, Vol. A 23 “Chemicals and Additives”, pp. 366-417 or Bayer AG “Manual for the Rubber Industry”, 2^{nd} Fully revised Edition, Leverkusen, 1993).

The vulcanizable compositions of the present invention may thus with preference additionally further contain one or more fillers such as, for example, carbon black, talcum, silica, calcium carbonate and (calcined) kaolin, (calcined) aluminosilicates, more preferably carbon black, silica, calcined aluminosilicates and/or calcined kaolin.

The vulcanizable compositions of the present invention may further additionally contain one or more plasticizers, for example dioctyl sebacate, dioctyl adipate, phosphoric esters, TOTM, etc.

Useful filler activators include, for example, organic silanes, such as vinyltrimethyloxysilane, vinyldimethoxymethylsilane, vinyltriethoxysilane, vinyltris(2-methoxyethoxy)silane, N-cyclohexyl-3-aminopropyltrimethoxysilane, 3-aminopropyltrimethoxysilane, methyltrimethoxysilane, methyltriethoxysilane, dimethyldimethoxysilane, dimethyldiethoxysilane, trimethylethoxysilane, isooctyltrimethoxysilane, isooctyltriethoxysilane, hexadecyltrimethoxysilane, (octadecyl)methyldimethoxysilane and epoxy-containing silanes, e.g. 3-glycidoxypropyltrimethoxysilane or 3-glycidoxypropyltriethoxysilane. Useful filler activators further include, for example, surface-active substances such as triethanolamine, trimethylolpropane, hexanetriol and polyethylene glycols having molecular weights of 74 to 10 000 g/mol. The amount of filler modifiers is typically in the range from 0 to 10 parts by weight, based on 100 parts by weight of the copolymer according to the present invention.

Any antioxidants known to a person skilled in the art may be included in the vulcanizable compositions, typically in amounts of 0 to 5 parts by weight, preferably 0.5 to 3 parts by weight, based on 100 parts by weight of the copolymers according to the present invention. CDPA and TMQ are used with preference.

Useful processing aids and/or mould-release agents include, for example, saturated or partially unsaturated fatty and oleic acids and their derivatives (fatty acid esters, fatty acid salts, fatty alcohols, fatty acid amides). Antiozonant waxes (trade-named Antilux® for example) may additionally be used as a processing aid, in low dosages. These aids and agents are employed in amounts of 0 to 10 parts by weight, preferably 0 to 2 parts by weight, more preferably 0 to 1 part by weight, based on 100 parts by weight of the copolymer according to the present invention. To further improve demouldability, products which can be applied to the mould surface, for example products based on low molecular weight silicone compounds, products based on fluoropolymers and also products based on phenolic resins, may be additionally employed.

Useful blowing agents to produce foamed products include, for example, OBSH and ADC.

Reinforcement with strength members (fibres) made of glass as taught in U.S. Pat. No. 4,826,721 is also possible, as is reinforcement through cords, wovens, fibres in aliphatic and aromatic polyamides (Nylons®, Aramid®), polyesters and natural-fibre products.

The vulcanizable composition of the present invention is preferably produced by using a conventional mixing assembly, e.g. a roll mill or an internal mixer, to mix copolymers of the present invention with the crosslinker, optionally one or more coagents and optionally further chemicals and added-substance materials as commonly employed in the rubber industry, for example those mentioned above. The mixing procedure may involve one or more steps.

Two possible modes of carrying out the invention will now be described by way of example:

### Process A: Production in Internal Mixer

At the start, the internal mixer (preferably an internal mixer with “intermeshing” rotor geometry) is charged with the copolymers of the present invention and comminutes the material. After a suitable period of mixing, the fillers and additives are admixed. The temperature is policed during the mixing process such that the material being mixed spends a suitable period at a temperature in the range from 80 to 150° C. After a further suitable mixing period, the further constituents of the mixture—like optionally stearic acid, coagents, antioxidants, plasticizers, white pigments (titanium dioxide for example), dyes and other processing actives—are admixed. After a further suitable mixing period, the internal mixer is vented and the shaft is cleaned. After a further suitable period, the crosslinker is admixed. Mixing temperature must be carefully policed at this stage to prevent any scorching in the mixer, if necessary, rotor speed has to be reduced to lower the mixing temperature. After a further suitable period, the internal mixer is emptied to obtain the vulcanizable mixture. A suitable period is to be understood as meaning a few seconds to some minutes. The vulcanizable mixtures thus obtained may be evaluated in a conventional manner, say in terms of the Mooney viscosity, in terms of Mooney Scorch or in terms of a rheometer test. Alternatively, it is possible to discharge the mixture without admixture of the crosslinker and to admix the crosslinker on a roll mill.

### Process B: Production on the Roll

The ingredients may be added similarly to process A above.

The vulcanization temperature of the copolymers according to the present invention and/or of the vulcanizable compositions containing same is typically in the range from 100 to 250° C., preferably from 140 to 220° C., more preferably from 160 to 200° C. If necessary or desired, the as-obtained vulcanizates may subsequently be conditioned at a temperature of about 150 to 200° C. for 1 to 24 hours in order to improve their end-product properties.

The vulcanizates obtainable by said vulcanization also form part of the subject-matter of the present invention. The term “vulcanizates” thus comprehends vulcanized copolymers of the present invention and vulcanized compositions containing the copolymers of the present invention and preferably one or more crosslinkers. Vulcanizates of this type perform very well in the compression set test at room temperature and 150° C. and exhibit high tensile stress values and good elongation at break values as well as a very good combination of low Oil Swell and low glass transition temperature.

The copolymers of the present invention and the vulcanizates and/or vulcanizable mixtures produced therefrom are useful in the manufacture of foamed or unfoamed mouldings and also in the manufacture of self-supported film/sheet and of coatings of any kind, in particular in the manufacture of cable conduction layers, cable sheathing, gaskets, transport belts, bellows, hoses, cylinder head cover gaskets and O-rings. The invention thus also encompasses the above mouldings containing the vulcanizates of the present invention. The vulcanizates of the present invention may further be admixed into plastics to serve as a non-volatile antistat. Therefore, the use of copolymers according to the invention to antistaticize polymers and the antistaticized plastics containing the vulcanizates of the present invention also form a further part of the subject-matter of the invention.

The copolymers of the present invention are further useful as elastomeric phase in thermoplastic vulcanizates and also as blend component in plastics or rubbers, preferably PVC, polyamide, polyester and/or HNBR.

Further possibilities of employment consist in the use of copolymers according to the present invention as non-volatile plasticizers and/or impact modifiers in plastics, preferably PVC, polyamide and/or polyester.

Therefore, thermoplastic vulcanizates containing the vulcanizates of the present invention as elastomeric phase and also plastics and rubbers containing the vulcanizates of the present invention, in particular as non-volatile plasticizers, and plastics containing the vulcanizates of the present invention as impact modifiers also form further parts of the subject-matter of the invention.

One significant advantage of the invention is that the vulcanizates of the present invention are the first to display an effective combination of oil resistance and low glass transition temperature.

### EXAMPLES

### Test Methods:

Glass transition temperature (Tg) is determined via Differential Scanning calorimetry (DSC) in accordance with EN ISO 11357-1:2009 and EN ISO 11357-2:2014, using helium as inert gas and determining the glass transition temperature by the inflection point method. Temperature scanning rate is 20 K/min for the copolymers and 10 K/min for the vulcanizates.

Copolymer composition was determined via ¹H NMR (Bruker DPX400 with XWIN-NMR 3.1 software, measurement frequency 400 MHz).

Gel permeation chromotography (GPC) was carried out in accordance with DIN 55672-1, Gel Permeation Chromotography (GPC) Part 1: Tetrahydrofuran (THF) as eluent, with addition of 0.5 wt % triethylamine. Polystyrene was used as standard.

Mooney viscosity (ML (1+4)100° C.) values are each determined using a shearing disc viscometer as per ISO 289 at 180° C.

Slabs to determine the mechanical properties were vulcanized in a Werner & Pfleiderer vulcanization press between Teflon foils under the stated conditions.

Shore A was determined to ASTM-D2240-81.

Tensile tests to determine stress as a function of deformation were carried out to DIN 53504 and/or ASTM D412-80.

Hot-air ageing was carried out to DIN 53508/2000. Method 4.1.1 “Ageing in oven with forced air circulation” was employed.

Immersion in oil and water was carried out in accordance with DIN ISO 1817.

Substances with Trade Names:

| | |
|---|---|
| VAMAC GLS | AEM from DuPont: 62.7 wt % of methyl acrylate, |
| | 33.4 wt % of ethylene, 3.9 wt % of monoethyl |
| | fumarate, T_{G} −25.6° C. |
| VAMAC DP | AEM from DuPont: 59.0 wt % of methyl acrylate, |
| | 41.0 wt % of ethylene, T_{G} −29° C. |
| SR550 | methoxypolyethylene glycol methacrylate (M_{w} |
| | of PEG unit 350 g/mol), from Sartomer Europe |
| SR552 | methoxypolyethylene glycol methacrylate (M_{w} |
| | of PEG unit about 553 g/mol), from Sartomer |
| | Europe |
| Antilux 110 | paraffin wax from Rheinchemie Rheinau GmbH |
| Rhenofit TAC/S | triallyl cyanurate 70% on 30% silica from |
| | Rheinchemie Rheinau GmbH |
| Rhenofit DDA | ageing control agent (diphenylamine derivative) |
| | from Rheinchemie Rheinau GmbH |
| Perkadox 14-40 B-PD | supported di(tert-butylperoxyisopropyl)benzene |
| | from AkzoNobel N.V. |
| Corax ® N550/30 | carbon black from Orion Engineered Carbons |
| | GmbH |

### Production of Copolymers:

### M1

The polymer was produced in a 5 L stirred autoclave. A 1492 g quantity of a solution consisting of 1490.0 g of tert-butanol and 2.0 g of methyl acrylate and also 252.5 g of an activator solution consisting of 2.5 g of AIBN (azobis(isobutyronitrile)), and 250.0 g of tert-butanol solution were successively sucked into the 5 L reactor at 30° C. The reactor was swept with nitrogen and then pressured with 960.0 g of ethylene. The temperature was raised to 70° C., establishing a pressure of about 380 bar. Then, a solution consisting of 200.0 g of methyl acrylate and 50.0 g of SR550 was metered into the reaction mixture for 9 h at a rate of about 0.46 g/min. Throughout the entire polymerization, the pressure was maintained at 380 bar±10 bar by injection of ethylene.

Following a reaction time of 10 h, the ethylene feed was stopped and the polymer solution was slowly forced out of the 5 L reactor into a termination autoclave. The solvent and residual monomers were removed to leave 312.0 g of an SR550-ethylene-methyl acrylate copolymer.
Mn=48 880 g/mol, Mw=109 106 g/mol, Mz=183 890 g/mol
ethylene=36.1 wt %, methyl acrylate=48.2 wt %, SR550=15.7 wt %
ML(1+4) 100° C.=<10; Tg=−34° C.

### M2

A four-neck flask fitted with Teflon stirrer and high-intensity condenser was charged under nitrogen with 75 g of water, 5.5 g of sodium dodecylsulphate, 62 g of ethyl acrylate, 24 g of butyl acrylate, 12 g of SR552 and 2 g of monoethyl fumarate. This was followed by the admixture of 0.002 g of sodium formaldehydesulphoxylate and 0.005 g of butyl hydroperoxide. The polymerization started and the temperature rose to 30° C. Following a polymerization time of 0.5 h, the polymer was precipitated with 20% aqueous NaCl solution. The polymer was then washed with water and vacuum dried at 75° C. to obtain 85 g of an acrylate rubber of the following composition:
ethyl acrylate: 62 wt %, butyl acrylate: 24.0 wt %, SR552: 12 wt %, monoethyl fumarate: 2.0 wt %
Tg=−31° C.

### Production of Vulcanizates and Vulcanizable Mixtures

The polymers were processed on the roll by method B into the recipes shown in table 1 below.

Vulcanization was carried out as a press cure at 180° C. (10 min for 2 mm thick slabs/specimens, 12 min for 6 mm thick slabs/specimens). After vulcanization, the slabs/specimens were conditioned at 176° C. for 4 h.

As can be seen from table 2, the vulcanizates produced from polymers according to the present invention display distinctly reduced glass transition temperatures for a comparable Oil Swell.

TABLE 1
Recipes of mixing tests, amounts in phr

| Example No. | M1 | M2 | VM1 | VM2 |
|---|---|---|---|---|
| Example 1 | 100 | | | |
| Example 2 | | 100 | | |
| Vamac DP | | | 100 | |
| Vamac GLS | | | | 100 |
| Corax N550 | 55 | 55 | 55 | 55 |
| Antilux 110 | 1.0 | | 1.0 | 1.0 |
| Rhenofit DDA | 1.4 | | 1.4 | 1.4 |
| Luvomaxx CDPA | | 2 | | |
| DIAK No 1 | | 0.9 | | |
| Rhenofit TAC/S | 2 | | 2 | 2 |
| Perkadox 14-40 | 5 | | 5 | 5 |
| Sum total | 184.4 | | 164.4 | 164.4 |

TABLE 2
Results of mixing tests

| Example No. | | M1 | M2 | VM1 | VM2 |
|---|---|---|---|---|---|
| ethylene content of | wt % | 36.1 | — | 41.0 | 33.4 |
| copolymer | | | | | |
| ML(1 + 4)100° C. | MU | 6 | | 38 | 41 |
| S′ min (MDR 180° C.) | dNm | 0.2 | 2.6 | 0.5 | 0.5 |
| S′ max (MDR 180° C.) | dNm | 8.3 | 11.5 | 15.8 | 11.2 |
| S′ max − S′ min | dNm | 8.1 | 8.9 | 15.3 | 10.7 |
| T95 (MDR 180° C.) | s | 501 | 418 | 433 | 484 |

Vulcanization press cure at 180° C.,
conditioning at 175° C. for 4 hr

| | | | | | |
|---|---|---|---|---|---|
| hardness | ShA | 66 | 60 | 68 | 72 |
| elongation at break | % | 238 | 112 | 213 | 268 |
| Tg (DSC) | ° C. | −33 | −31 | −29 | −22 |

Immersion 70 h/150° C. IRM 903

| | | | | | |
|---|---|---|---|---|---|
| change in mass | % | 29 | 12 | 35 | 23 |
| chane in volume | % | 42 | 16 | 49 | 32 |
| hardness | ShA | 41 | 55 | 50 | 50 |
| elongation at break | % | 181 | 98 | 149 | 218 |

Example M1, which is in accordance with the present invention, has a distinctly lower glass transition temperature as compared with the comparators VM1 and VM2 while other physical properties, such as elongation at break, Oil Swell, etc., correspond to the ethylene content. The surprisingly lower Mooney viscosity in the case at Working Example M1 would even permit an increase in the peroxide quantity used for the vulcanization, thereby making possible a further reduction in Oil Swell without causing an increase in the glass transition temperature.

1. Copolymers for the manufacture of vulcanizates and vulcanizable compositions, the copolymers comprising:
i) 49 to 99 wt % of repeat units derived from at least one alkyl acrylate other than repeat units ii),
ii) 1 to 51 wt % of repeat units derived from at least one monomer of general formula (I)
CH₂═C(R¹)(COO(R²O)ₙR³) (I)
where
R¹ represents hydrogen or methyl,
R² at each occurrence independently represents a linear or branched C₂ to C₆ alkylene group,
R³ represents hydrogen, unsubstituted or C₁-C₃ alkyl substituted phenyl, a linear or branched C₁-C₈ alkyl group or —C(═O)R⁴,
R⁴ represents hydrogen or a linear or branched C₁-C₈ alkyl group, and
n represents a number from 2 to 30, and
iii) 0 to 50 wt % of repeat units derived from ethylene,
wherein the amounts are each based on the combined amount of repeat units i) to iii).

2. The copolymers according to claim 1, wherein the alkyl acrylates have an alkyl moiety of 1 to 10 carbon atoms and preferably are selected from methyl acrylate, ethyl acrylate, propyl acrylate, isopropyl acrylate, n-butyl acrylate, n-hexyl acrylate, 3-propylheptyl acrylate, 2-ethylhexyl acrylate, n-octyl acrylate and also mixtures thereof, more preferably methyl acrylate, ethyl acrylate and n-butyl acrylate and also mixtures thereof.

3. The copolymers according to claim 1, wherein the copolymers contain 2 to 40 wt % of monomers of general formula (I), all based on the sum total of repeat units i) to iii).

4. The copolymers according to claim 1, wherein the R² moieties at each occurrence are independently selected from the group consisting of ethane-1,2-diyl, propane-1,3-diyl, propane-1,2-diyl, butane-1,4-diyl, butane-1,3-diyl, pentane-1,3-diyl, pentane-1,4-diyl, pentane-1,5-diyl and 2-methylbutane-1,4-diyl, preferably from ethane-1,2-diyl, propane-1,3-diyl, propane-1,2-diyl and butane-1,4-diyl, more preferably from ethane-1,2-diyl and propane-1,2-diyl.

5. The copolymers according to claim 1, wherein the R³ moieties are selected from the group consisting of H, CH₃, CH₂CH₃, CH₂CH₂CH₃, CH₂CH₂CH₂CH₃, CHO, COCH₃, COCH₂CH₃, COCH₂CH₂CH₃ and COCH₂CH₂CH₂CH₃, preferably from H, CH₃, CH₂CH₃ and COCH₃ and more preferably from CH₃, CH₂CH₃ and COCH₃.

6. The copolymers according to claim 1, wherein the copolymers include one or more further copolymerized monomers (iv) in a combined amount of less than 25 wt %, preferably less than 20 wt %, more preferably less than 15 wt %, yet more preferably less than 10 wt %, yet still more preferably less than 5 wt % and most preferably less than 1 wt %, all based on the combined amount of repeat units i) to iii) and of the one or more further copolymerized monomers (iv).

7. The copolymers according to claim 6, wherein the further copolymerized monomers (iv) are selected from epoxy-containing acrylates, epoxy-containing methacrylates, alkoxyalkyl acrylates having an alkoxyalkyl group of 2 to 8 carbon atoms, vinyl ketones, vinylaromatic compounds, conjugated dienes, α-monoolefins, vinyl monomers having a hydroxyl group, chlorovinyl acetate, monoalkyl maleate, monoalkyl fumarate, acrylic acid, methacrylic acid, vinylidene fluoride, hexafluoropropene, vinylidene chloride, tetrafluoroethylene, tetrachloroethylene, vinyl chloride, unsaturated amide monomers, carbon monoxide and mixtures thereof, preferably from methyl acrylate, ethyl acrylate, propyl acrylate, n-butyl acrylate, 2-ethylhexyl acrylate, n-octyl acrylate, glycidyl methacrylate, divinyl adipate, methyl vinyl ketone, ethyl vinyl ketone, styrene, α-methylstyrene, vinyltoluene, butadiene, isoprene, propylene, 1-butene, β-hydroxyethyl acrylate, 4-hydroxybutyl acrylate, 3-cyanoethyl acrylate, acrylamide, N-methylmethacrylamide, 2-methoxyethyl acrylate, chlorovinyl acetate, monoalkyl maleate, monoalkyl fumarate, carbon monoxide and mixtures thereof and more preferably from acrylic add, methacrylic acid, 2-methoxyethyl acrylate, glycidyl methacrylate, chlorovinyl acetate, monoalkyl maleate, monoalkyl fumarate, carbon monoxide and mixtures thereof.

8. The copolymers according to claim 1, wherein the copolymers contain repeat units derived from ethylene, methyl acrylate and polyalkylene glycol (meth)acrylates having 2 to 20 ethylene glycol and/or propylene glycol repeat units, preferably together with repeat units derived from butyl acrylate, monoalkyl maleate and/or monoalkyl fumarate.

9. The copolymers according to claim 1, wherein the copolymers contain repeat units derived from two or more alkyl acrylates, preferably ethyl acrylate and butyl acrylate, and polyalkylene glycol (meth)acrylates having 2 to 20 ethylene glycol and/or propylene glycol repeat units.

10. A process for producing vulcanizable compositions, the process comprising mixing the copolymers according to claim 1 with one or more crosslinkers.

11. Vulcanizable compositions comprising: The copolymers according to claim 1, one or more crosslinkers, and optionally coagents for enhancing the crosslinking yield.

12. A process for producing vulcanizates, the process comprising crosslinking the vulcanizable compositions according to claim 11.

13. Vulcanizates obtained from the copolymers according to claim 1.

14. Articles of manufacture comprising the copolymers according to claim 1 wherein the articles of manufacture are foamed or unfoamed mouldings, cable conduction layers, cable sheathing, gaskets, transport belts, bellows, hoses, cylinder head cover gaskets, and O-rings.

15. Non-volatile plasticizer and/or impact modifier for plastics comprising the copolymers according to claim 1.

16. Plastics or rubbers comprising the copolymers according to claim 1 as a blend component.

17. The copolymer according to claim 1, wherein the copolymer comprises:
55 to 90 wt % of the repeat units derived from the at least one alkyl acrylate other than repeat units ii),
4 to 25 wt % of monomers of general formula (I), and
>0 to 45 wt % of repeat units derived from ethylene,
wherein the amounts are each based on the combined amount of repeat units i) to iii).

18. The copolymer according to claim 17, wherein the copolymer comprises:
6 to 20 wt % of monomers of general formula (I); and
>20 to 45 wt % of repeat units derived from ethylene,
all based on the sum total of repeat units i) to iii).
